(19) United States
(12) Patent Application Publication
(10) Pub. No.: US 2016/0110755 A1
(43) Pub. Date: Apr. 21, 2016

(54) ONLINE AD CAMPAIGN TUNING WITH PID CONTROLLERS

(71) Applicant: Yahoo! Inc., Sunnyvale, CA (US)

(72) Inventors: Yury Smirnov, Palo Alto, CA (US); Quan Lu, San Diego, CA (US); Kuang-chih Lee, Union City, CA (US)

(73) Assignee: Yahoo! Inc., Sunnyvale, CA (US)

(21) Appl. No.: 14/518,601

(22) Filed: Oct. 20, 2014

(51) Int. Cl. G06Q 30/02

(52) U.S. Cl. CPC G06Q 30/0244

(57) ABSTRACT

Described herein are techniques and systems for online ad campaign tuning using proportional-integral-derivative (PID) controllers, such as proportional (P) controllers and proportional-integral (PI) controllers. Also, described herein are techniques and systems for shortening a learning/tuning phase of a PID controller used for optimizing an online ad campaign.

### BACKGROUND

This application relates to online ad campaign tuning with controllers, such as proportional-integral-derivative (PID) controllers, proportional (P) controllers, and proportional-integral (PI) controllers.

Increasingly, advertising is being integrated with online content. Online audiences are demanding free content or at least content delivered at below market prices. Because of this demand, publishers and content networks may be delivering ads with such content to compensate for lost profits. The delivery of online ads may be through various channels, such as search, mobile search, display, mobile display, and native advertising.

One way to make use of the variety of online advertising channels is through a unified approach to digital advertising (e.g., Yahoo Ad Manager and Ad Manager Plus). Such a unified approach can reduce some of the issues faced with online advertising. For example, online advertising can be fragmented and difficult to ascertain. A unified approach can be customer-friendly by making access to various advertising channels through a unified interface. This allows customers to target and even retarget audiences seamlessly through various channels. However, by unifying various channels, analysis and optimization of such a unified marketplace can be extremely complex and difficult to model.

In targeted online advertising, advertisers look for maximizing campaign performance goals within budget schedules. Often customers prefer to impose delivery constraints to spend budget consistently and reach a wider range of audiences, and still have a sustainable impact on audiences. Also, since impressions and clicks are traded through auctions across many ad exchanges for online advertising, pricing on impressions and clicks can change rapidly and dynamically, as can the supply and demand for advertising opportunities online. Therefore, it can be challenging to optimize pricing and campaign performance.

The common techniques of optimizing ad campaigns, such as using various types of modeling, are helpful but may not be well adapted to the complexities that arise in a unified online advertising marketplace, at least not in the short term. Therefore, there is a set of engineering problems to be solved in order to provide advertising through various channels optimally. Such solutions could also simplify optimization of single channel ad campaigns as well, especially when the modeling for a given campaign is complex.

The novel technologies described herein set out to solve the problem of online campaign tuning and optimization on a large scale, such as a scale presented by wide-reaching, multi-channel online advertising campaigns. They also set out to solve the problem of overly complex modeling that can even occur in single-channel ad campaigns. At this point, there has not been a viable solution to scale for resolving the aforementioned problems in an online advertising.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can communicatively couple with an example control system (such as a control system within campaign tuning server 116) that can provide online ad campaign tuning using a controller.

FIG. 2 illustrates displayed ad items and content items of example screens rendered by client-side applications associated with the information system illustrated in FIG. 1.

FIG. 3 illustrates a block diagram of an example PID controller within an example control system (such as the control system within campaign tuning server 116).

FIG. 4 illustrates a block diagram of an example PI controller within an example control system (such as the control system within campaign tuning server 116).

FIG. 5 illustrates a plot of a measured process variable y(t) versus time t for three values of a proportional gain coefficient (Kₚ) of an example controller.

FIG. 6 illustrates a plot of a line between between an origin and two goals. The curved line in FIG. 6 can represent a pre-defined arbitrary and monotonically decreasing surface from a goal point to an origin with absence of noise, and values of a goal variable, r(t), can be defined by the surface.

FIG. 7 illustrates example operations performed by a system, such as the information system illustrated in FIG. 1, which can provide online ad campaign tuning using a controller, such as a PID controller, PI controller, or a P controller.

FIG. 8 is a block diagram of an example electronic device, such as a server, that can implement aspects of and related to an example control system, such as a control system of the campaign tuning server 116.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### Overview

The use of controllers (such as PID controllers, PI controllers, and P controllers) can provide simplistic techniques for tuning and optimizing online ad campaigns. Conventional modeling techniques for online advertising can become complex and impractical at times, especially considering that online ad campaigns are becoming more complex. Controllers widely used in mechanical, chemical, and electrical processes, and other types of industrial processes, can also be used for directing online commerce. Described herein are controllers for use with electrical commerce processes, such as processes associated with online ad campaigns.

Controllers are beneficial in that an underlying process model does not need to be designed for a controlled process. To control a process, a provider may merely need to design an error function. In an example, to automate ad campaign control, a provider may design an error function and tune controller coefficients based on a chosen time granularity to guide conversion of a controlled process to desired values of selected metrics. There have been attempts to use controllers in online advertising; however, design of the error function and learning phases (also known as trial and error tuning phases) may have been too slow for online ad systems having a wide reach. This may be due to online advertising becoming extremely complex, especially with unified marketplaces. Described herein are improvements to controllers and use of such improvements with ad campaigns. Also, described herein are techniques for rapid design of an error function and dramatically reducing the length of time for learning and/or tuning phases (hereinafter learning/tuning phase) of a controller.

Launch policies for a controller can be designed for advertising campaigns with an effective error function design that focuses on guiding processes toward obtainable goals and periodic controller feedback collection instead of continuous corrections. These two foci can help reduce the length of a learning/tuning phase dramatically. Additionally, the periodic tuning can be accelerated by educated guesses, such as extrapolation of control values for control variables for follow-up time periods and an educated guess for the starting point of a learning/tuning phase instead of starting at zero or another origin. The effective error function design that focuses on a more obtainable goal may include design of an error function that converges to an equilibrium surface instead of a single set point. Such a design may also focus on the error function maintaining solely a selected sign, for example maintaining positive metrics, instead of convergence to a specific value. Also, the equilibrium surface can connect the goal and the origin (or another starting point), and a priori can define the set of desirable values of a goal variable, r(t). Where goal metrics cannot be reached, the system can provide for design of an error function and use of the controller as a mechanism directing a controlled process toward the equilibrium surface. In other words, the controller can direct a parameter of the ad campaign toward the goal when possible; it can otherwise direct the parameter towards convergence to one of the multi-criteria points on the equilibrium surface. These design techniques can be especially useful when advertising campaigns have a goal including several goal metrics that cannot be reached simultaneously.

Error function design and controller coefficients tuning can be a lengthy part of the learning/tuning phase, which can include setting one or more changes of the controller coefficients and the error function so that a desired rate of convergence is achieved. This part can be especially long when an ad campaign includes multiple goals. Lower scale of gains, such as coefficient gains, can result in a slower than desired convergence and higher scale of gains can result in unwanted oscillation. The system described herein can adjust gains quickly by a semi-automated search with a shorter time period to achieve a more obtainable goal and avoid excessive oscillation.

Also, because ad campaigns can be diverse and fluctuate between impressions, sites, users, time of the day and such, analysis and utilization of aggregated ad campaign execution data over a time period with consistent bidding policy parameters can direct a given campaign toward a goal and tuning can be shortened. The selected time granularity alongside with the consistency of bidding policy parameters can be used to tune a controller and design the error function to penalize deviation from the goal. After multiple periods (such as two or three periods) of directing the ad campaign towards the goal, the system can determine gains for the controller. After the learning/tuning phase and the determination of gains, the controller can control the campaign according to the determined gains with a reduced possibility of underscaling or overscaling.

Besides reducing inherent fluctuating factors of ad campaigns, before utilizing a controller with calculated gains the system can use extrapolation that reduces the length of the learning/tuning phase by bringing selected metric values of ad campaigns closer to desired values. This time-diminishing extrapolation can cause faster convergence towards the goal. Also, with the use of such extrapolation, enough information about the behavior of the ad campaign may exist to set gains of the controller and switch the campaign management over to the controller.

### DESCRIPTION OF THE DRAWINGS

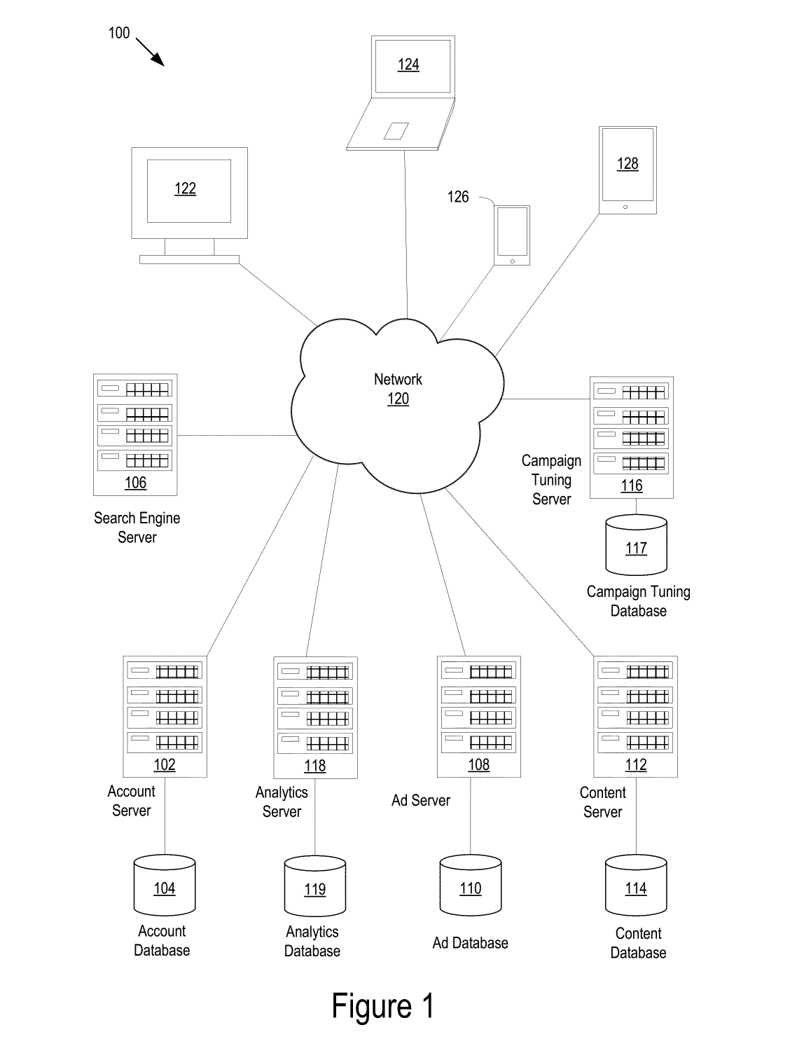

FIG. 1 illustrates a block diagram of an example information system that includes example devices of a network that can communicatively couple with an example system that provides online ad campaign tuning with a PID controller. The information system 100 in the example of FIG. 1 includes an account server 102, an account database 104, a search engine server 106, an ad server 108, an ad database 110, a content database 114, a content server 112, a campaign tuning server 116, a campaign tuning database 117, an analytics server 118, and an analytics database 119. The aforementioned servers and databases can be communicatively coupled over a network 120. The network 120 may be a computer network. The aforementioned servers may each be one or more server computers.

The information system 100 may be accessible over the network 120 by advertiser devices and audience devices, which may be desktop computers (such as device 122), laptop computers (such as device 124), smartphones (such as device 126), and tablet computers (such as device 128). An audience device can be a user device that presents online advertisements, such as a device that presents online advertisements to an audience member. In various examples of such an online information system, users may search for and obtain content from sources over the network 120, such as obtaining content from the search engine server 106, the ad server 108, the ad database 110, the content server 112, and the content database 114. Advertisers may provide advertisements for placement on online properties, such as web pages, and other communications sent over the network to audience devices. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content.

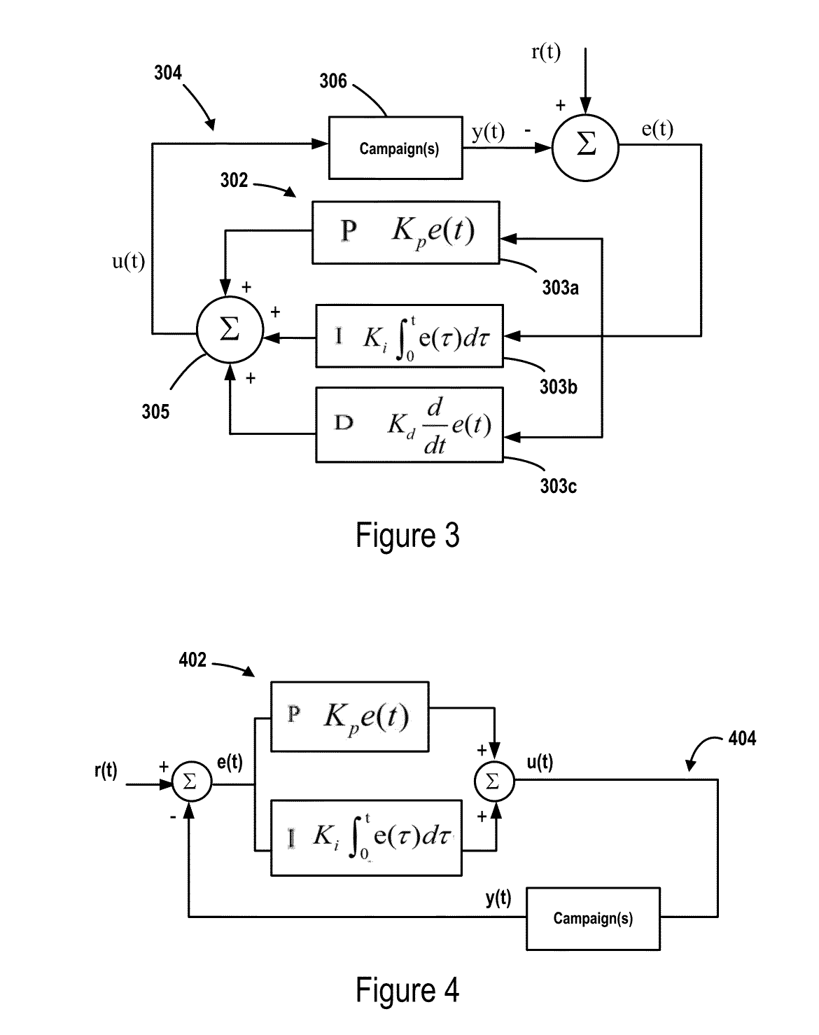

The account information may include ad booking information, and such booking information may be communicated to the analytics server 118 for processing and then used by the campaign tuning server 116 for controlling related ad campaigns. This booking information can be used as input for determining any of the variables y(t), r(t), and e(t) associated with a controller and any of the gain coefficients Kₚ, Kᵢ, and K_{d} used as gain for a controller. Parts of the booking information can be derived from the variable u(t) associated with output of a controller. The variables u(t), y(t), r(t), and e(t) and the gain coefficients Kₚ, Kᵢ, and K_{d} are described in more detail within the descriptions of FIGS. 3-7. Besides booking information, any data or information outputted by processes of the servers of FIG. 1 may be communicated to the analytics server 118 for processing and then used by the campaign tuning server 116 for controlling related ad campaigns. Such data and information may be used as input for determining any of the variables y(t), r(t), and e(t) and any of the gain coefficients Kₚ, Kᵢ, and K_{d}. Also, parts of such data and information can be derived from the variable u(t).

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser. The advertiser front end may be a program, application, or software routine that forms a user interface. In a particular example, the advertiser front end is accessible as a website with electronic properties that an accessing advertiser may view on an advertiser device, such as one of the devices 122-128 when logged on by an advertiser. The advertiser may view and edit account data and advertisement data, such as ad booking data, using the advertiser front end. After editing the advertising data, the account data may then be saved to the account database 104.

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices over the network 120. An audience client device may communicate a user query to the search engine server 106. For example, a query entered into a query entry box can be communicated to the search engine server 106. The search engine server 106 locates matching information using a suitable protocol or algorithm and returns information to the audience client device, such as in the form of ads or content.

The search engine server 106 may be designed to help users and potential audience members find information located on the Internet or an intranet. In an example, the search engine server 106 may also provide an electronic property with content to the audience client device over the network 120, such as a web page, including search results, information matching the context of a user inquiry, links to other network destinations, or information and files of information of interest to a user operating the audience client device, as well as a stream or web page of content items and advertisement items selected for display to the user. This information provided by the search engine server 106 may be logged, and such logs may be communicated to the analytics server 118 for processing and analysis. Besides this information, any data and information outputted by processes of the servers of FIG. 1 may also be logged, and such logs can also be communicated to the analytics server 118 for further processing and analysis. Once processed into corresponding analytics data, the analytics data can be input for determining any of the variables y(t), r(t), and e(t), and any of the gain coefficients Kₚ, Kᵢ, and K_{d}. Also, without processing by the analytics server 118, more raw forms of data and information (such as any of the data or information described with respect to FIG. 1) may also be used as input for determining any of the variables y(t), r(t), and e(t) and any of the gain coefficients Kₚ, Kᵢ, and K_{d}.

The search engine server 106 may enable a device, such as an advertiser client device or an audience client device, to search for files of interest using a search query. Typically, the search engine server 106 may be accessed by a client device (such as the devices 122-128) via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 may be one or more servers. Alternatively, the ad server 108 may be a computer program, instructions, and/or software code stored on a computer-readable storage medium that runs on one or more processors of one or more servers. The ad server 108 operates to serve advertisements to audience devices. An advertisement may include text data, graphic data, image data, video data, or audio data. Advertisements may also include data defining advertisement information that may be of interest to a user of an audience device. The advertisements may also include respective audience targeting information and/or ad campaign information. An advertisement may further include data defining links to other online properties reachable through the network 120. The aforementioned audience targeting information and the other data associated an ad may be logged in data logs.

For online service providers, advertisements may be displayed on electronic properties resulting from a user-defined search based, at least in part, upon search terms. Also, advertising may be beneficial and/or relevant to various audiences, which may be grouped by demographic and/or psychographic. A variety of techniques have been developed to determine audience groups and to subsequently target relevant advertising to members of such groups. Group data and individual user's interests and intentions along with targeting data related to campaigns may be may be logged in data logs. As mentioned, one approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users. Similarly, the aforementioned profile-type targeting data may be logged in data logs. Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data may be logged in data logs.

The ad server 108 includes logic and data operative to format the advertisement data for communication to an audience member device, which may be any of the devices 122-128. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned advertising data may be logged in data logs.

Further, the ad server 108 is in data communication with the network 120. The ad server 108 communicates ad data and other information to devices over the network 120. This information may include advertisement data communicated to an audience device. This information may also include advertisement data and other information communicated with an advertiser device. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the campaign tuning server 116, the analytics server 118, and/or the account server 102. Ad items and ad information, such as pricing information, can be used as input for determining any of the variables y(t), r(t), and e(t), and any of the gain coefficients Kₚ, Kᵢ, and K_{d}. Also, parts of the aforementioned information can be derived from the variable u(t).

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may be saved to the ad database 110 for subsequent communication in advertisements to an audience device. In viewing and editing the advertising data, adjustments can be used as input for determining any of the variables y(t), r(t), and e(t), and any of the gain coefficients Kₚ, Kᵢ, and K_{d}. Also, parts of the advertising data can be derived from the variable u(t) (hereinafter referred to as u(t)). The advertiser front end may also provide a graphical user interface for simulating ad campaigns according to a controller.

The content server 112 may access information about content items either from the content database 114 or from another location accessible over the network 120. The content server 112 communicates data defining content items and other information to devices over the network 120. The information about content items may also include content data and other information communicated by a content provider operating a content provider device. A content provider operating a content provider device may access the content server 112 over the network 120 to access information. This access may be for developing content items, editing content items, deleting content items, setting and adjusting bid amounts and other activities, such as associating content items with certain types of ad campaigns. A content provider operating a content provider device may also access the campaign tuning server 116 over the network 120 to access analytics data and controller related data. Such analytics and controller data may help focus developing content items, editing content items, deleting content items, setting and adjusting bid amounts, and activities related to distribution of the content.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120. In editing the content data, adjustments to controller variables and parameters may be determined and presented upon editing of the content data, so that a publisher can view how changes affect stability of ad campaigns.

The content provider front end may be a client-side application. A script and/or applet and the script and/or applet may manage the retrieval of campaign data. In an example, this front end may include a graphical display of fields for selecting audience segments, segment combinations, or at least parts of campaigns. Then this front end, via the script and/or applet, can request data related to campaign stability from the campaign tuning server 116. The information related to campaign stability can then be displayed, such as displayed according to the script and/or applet.

The content server 112 includes logic and data operative to format content data for communication to the audience device. The content server 112 can provide content items or links to such items to the analytics server 118 or the campaign tuning server 116 to associate with campaign stability. For example, content items and links may be matched to such data. The matching may be complex and may be based on historical information related to control of campaigns.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data and other information and data outputted by the content server may be logged in data logs. For example, content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include FLICKER, TWITTER, FACEBOOK, LINKEDIN, or a personal user site (such as a blog, vlog, online dating site, etc.). An online server system may also host a variety of other sites, including business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

An advertiser client device, which may be any one of the devices 122-128, includes a data processing device that may access the information system 100 over the network 120. The advertiser client device is operative to interact over the network 120 with any of the servers or databases described herein. The advertiser client device may implement a client-side application for viewing electronic properties and submitting user requests. The advertiser client device may communicate data to the information system 100, including data defining electronic properties and other information. The advertiser client device may receive communications from the information system 100, including data defining electronic properties and advertising creatives. The aforementioned interactions and information may be logged in data logs.

In an example, content providers may access the information system 100 with content provider devices that are generally analogous to the advertiser devices in structure and function. The content provider devices provide access to content data in the content database 114, for example.

An audience client device, which may be any of the devices 122-128, includes a data processing device that may access the information system 100 over the network 120. The audience client device is operative to interact over the network 120 with the search engine server 106, the ad server 108, the content server 112, the campaign tuning server 116, and the analytics server 118. The audience client device may implement a client-side application for viewing electronic content and submitting user requests. A user operating the audience client device may enter a search request and communicate the search request to the information system 100. The search request is processed by the search engine and search results are returned to the audience client device. The aforementioned interactions and information may be logged.

In other examples, a user of the audience client device may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device. The aforementioned interactions and information may be logged in data logs and such logs.

An advertiser client device and an audience client device operate as a client device when accessing information on the information system 100. A client device, such as any of the devices 122-128, may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, FACEBOOK, LINKEDIN, TWITTER, FLICKR, OR GOOGLE+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities. At least some of the features, capabilities, and interactions with the aforementioned may be logged in data logs.

Also, the disclosed methods and systems may be implemented at least partially in a cloud-computing environment, at least partially in a server, at least partially in a client device, or in a combination thereof.

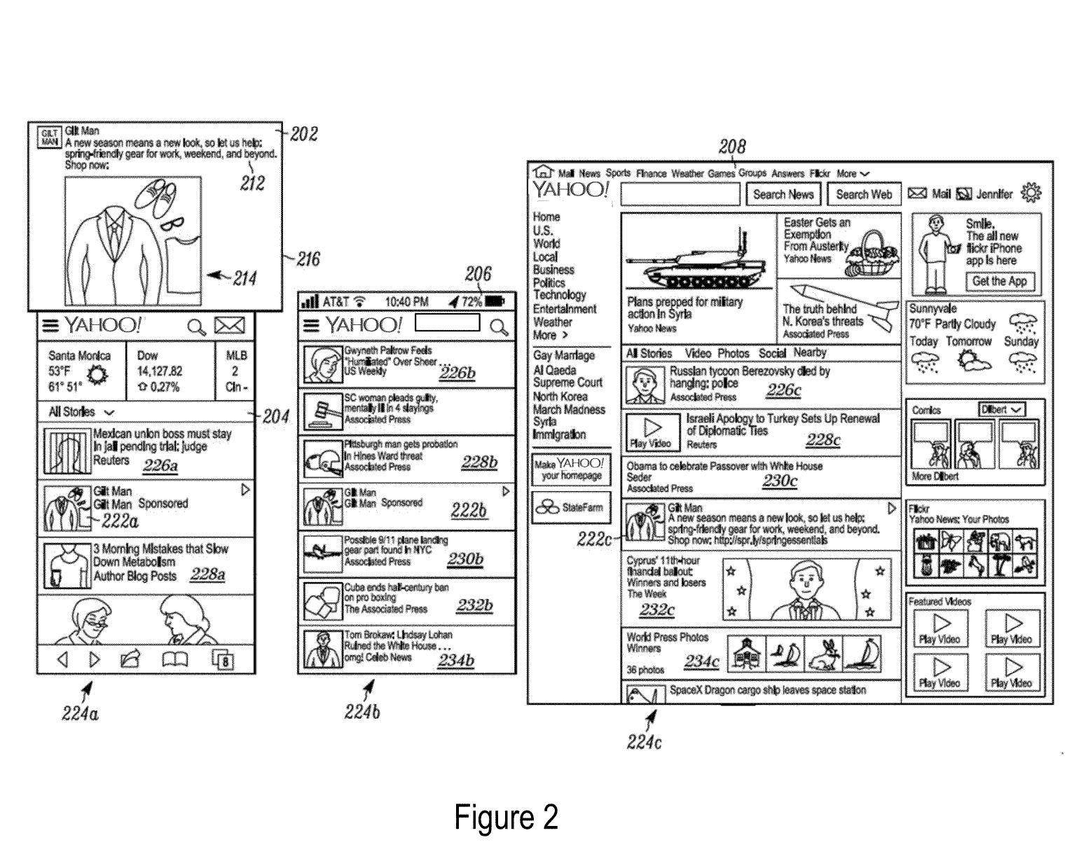

FIG. 2 illustrates displayed ad items and content items of example screens rendered by client-side applications. The content items and ad items displayed may be provided by the search engine server 106, the ad server 108, or the content server 112. User interactions with the ad items and content items can be tracked and logged in data logs, and the logs may be communicated to the analytics server 118 for processing. Once processed into corresponding analytics data, such data can be input for determining controller related variables (such as y(t), r(t), and e(t)) and controller gains (such as gain coefficients Kₚ, Kᵢ, and K_{d}).

In FIG. 2, a display ad 202 is illustrated as displayed on a variety of displays including a mobile web device display 204, a mobile application display 206 and a personal computer display 208. The mobile web device display 204 may be shown on the display screen of a smart phone, such as the device 126. The mobile application display 206 may be shown on the display screen of a tablet computer, such as the device 128. The personal computer display 208 may be displayed on the display screen of a personal computer (PC), such as the desktop computer 122 or the laptop computer 124.

The display ad 202 is shown in FIG. 2 formatted for display on an audience device but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable. Such formatting specifications may be logged in data logs and such logs may be communicated to the analytics server 118 for processing. Once processed into corresponding analytics data, such data can be input for determining controller related variables and parameters.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers. However, these content items may include advertising components. Each of the streams 224a, 224b, and 224c may include a number of content items and advertising items.

In an example, the streams 224a, 224b, and 224c may be arranged to appear to the user as an endless sequence of items. A user of an audience device on which one of the streams 224a, 224b, or 224c is displayed, may scroll the display, and a seemingly endless sequence of items may appear in the displayed stream. The scrolling can occur via the scroll bars, for example, or by other known manipulations, such as a user dragging his or her finger downward or upward over a touch screen displaying the streams 224a, 224b, or 224c. To enhance the apparent endless sequence of items so that the items display quicker from manipulations by the user, the items can be cached by a local cache and/or a remote cache associated with the client-side application or the page view. Such interactions may be communicated to the analytics server 118; and once processed into corresponding analytics data, such data can be input for determining controller related variables and parameters.

The content items positioned in any of streams 224a, 224b, and 224c may include news items, business-related items, sports-related items, etc. Further, in addition to textual or graphical content, the content items of a stream may include other data as well, such as audio and video data or applications. Each content item may include text, graphics, other data, and a link to additional information. Clicking or otherwise selecting the link re-directs the browser on the client device to an electronic property referred to as a landing page that contains the additional information. The clicking or otherwise selecting of the link, the re-direction to the landing page, the landing page, and the additional information can each be tracked, and then the data associated with the tracking can be logged in data logs, and such logs may be communicated to the analytics server 118 for processing. Once processed into corresponding analytics data, such data can be input for determining controller related variables and parameters.

Stream ads like the advertising items 222a, 222b, and 222c may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the client device to an electronic property referred to as a landing page. The clicking or otherwise selecting of the link, the re-direction to the landing page, the landing page, and the additional information, for example, can each be tracked, and then the data associated with the tracking can be logged in data logs, and such logs may be communicated to the analytics server 118 for processing. Once processed into corresponding analytics data, such data can be input for determining controller related variables and parameters.

While the example streams 224a, 224b, and 224c are shown with a single visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. Also, slotting may be according to campaign control. The slotting and any other operation associated with campaign control described herein may occur via controller interface circuitry that provides interfacing between a controller and other types of circuitries, such as circuitry of any of the servers illustrated in FIG. 1. The controller interface circuitry and the controller may be hosted on the campaign tuning server 116.

FIG. 3 illustrates a block diagram of an example PID controller 302 within an example feedback loop 304 within an example control system (such as the control system within campaign tuning server 116). The PID controller 302 and any other controller or aspect described herein may be implemented via circuitry, such as electronic circuitry. Additionally or alternatively, the PID controller 302 and any other controller or aspect described herein may be at least partially implemented via software and/or firmware. Also, interfaces to the controller 302 may be made accessible to other analytics circuitry, such as gain coefficient tuning circuitry.

An interface of the PID controller 302 may include inputs that can be used to calculate an error variable e(t), which may represent some form of a difference between a measured process variable y(t) and a goal variable r(t). One task of the PID controller 302 can be to reduce the error value by adjusting inputs of the controlled process. The rate of reduction depends on the controller's settings, such as the values of gain coefficients Kₚ, Kᵢ, and K_{d} corresponding to the proportional aspect 303a, the integral aspect 303b, and the derivative aspect 303c of the PID controller. The gain coefficients Kₚ, Kᵢ, and K_{d} may be associated with one or more controllable aspects of a campaign.

The proportional aspect 303a of the PID controller 302 may relate to real-time error, the integral aspect 303b may relate to an accumulation of past errors, and the derivative aspect 303c may be a prediction of future errors based at least on rate of change in the error value. Additionally or alternatively, besides continuous correction and the integral form of the integral aspect 303b, the system may use a time period-based time scale and a summation 305 of the aspects 303a-303c (such as a weighted summation of these three aspects) to adjust one or more variables of one or more online advertising campaigns 306.

The PID controller 302 can be useful in directing adjustments to online campaigns, especially complex campaigns taking advantage of multiple online advertising channels, because time-consuming modelling and analysis are not needed to effectively tune such campaigns. By merely designing an error function e(t) and setting gain coefficients of the PID controller 302 (such as any one or more of the gain coefficients Kₚ, Kᵢ, and K_{d}), the controller can provide direction according to process specifications. In an example, a result of the controller 302 can include a degree of responsiveness to an error, a degree to which the controller overshoots a pre-defined goal, and a degree of system oscillation.

As exemplified, in FIG. 4, some examples of a PID controller may only use one or two of the aspects 303a-303c. This can occur by setting one or two of the aspects 303a-303c to zero. Where each of the three aspects 303a-303c is implemented by circuitry, one or two of the aspects may be removed. For example, circuitry implementing the PI controller 402 may only include circuitry for proportional and integral aspects. Alternatively, circuitry implementing the PI controller 402 may include circuitry for all the aspects of a PID controller, but the derivative aspect is set to output zero, voided, or switched off. PI controllers are useful, since derivative action can be sensitive to noise, whereas the absence of the integral aspect may prevent a controlled campaign from reaching or even approaching its pre-defined goal.

In an example, a control loop directed by the PID controller 302 can manually and/or automatically adjust parameters of an online advertising campaign to achieve or at least approach pre-defined goals of the campaign. Results of a campaign to compare against the pre-defined goals may include analytics, such as any of the analytics described with respect to FIGS. 1 and 2. Results of a campaign to compare against the pre-defined goals may also include data from logs, such as of the data logs described with respect to FIGS. 1 and 2. The measured process variable y(t) may include the results of a campaign to be compared against the pre-defined goals that may be included in the goal variable r(t). The pre-defined goals can include one or more set points. The controlled input variable of the u(t), which can be the output of the PID controller 302 may be referred to as manipulated variables or controlled variables, since such parameters are controlled by the PID controller. A difference between the y(t) and the r(t) is an error variable e(t), which may be an error value or an error function. Also, each of the variables y(t), r(t), u(t), and e(t) can be a value, a set of values, a function, a set of functions, or any combination thereof. The e(t) quantifies whether the campaign is meeting its pre-defined goals and the extent that it is meeting the goals. As illustrated in FIG. 3, the PID controller 302 determines the u(t) according to the e(t) and the proportional aspect 303a, the integral aspect 303b, the derivative aspect 303c, or any combination thereof.

In an example, the proportional aspect 303a is set in proportion to the e(t). The derivative aspect 303c uses a rate of change in the y(t). The integral aspect 303b uses an average and/or accumulated y(t) from the past. An alternative of integral aspect 303b can use change of the u(t) in steps proportional to the e(t). Over time, the steps add up the past errors (which is a discrete time equivalent to integration).

In adjusting any of the three aspects 303a-303c (such as by adjusting the Kₚ, Kᵢ, and/or K_{d}), a change that is too large when the error is small may lead to overshoot. Where the PID controller 302 repeatedly make changes that are too large and overshoot the r(t), output of the PID controller (such as u(t)) may oscillate around one or more of the set points in either a constant, growing, or a decaying sinusoid. In examples wherein the amplitude of the oscillations increases with time, i.e., the sinusoid is growing, the campaign is unstable. If the amplitude of the oscillations decreases, the campaign is stable. If the oscillations remain at a constant amplitude, the campaign is marginally stable.

In an example, the controller 302 may dampen anticipated future oscillations by tempering its adjustments, or reducing a controller gain. This may cause a gradual convergence towards the r(t). If the controller 302 starts from a stable state with zero error (e.g., y(t)=r(t)), then adjustments to the controller can be in response to changes in other measured or set inputs to the campaign that affect the campaign, and hence the y(t). Variables that affect the campaign other than the u(t) are known as disturbances. The controller 302 may reject disturbances.

As mentioned herein, the controller 302 can output manipulated variables, such as the u(t), according to the summation 305 of the aspects 303a-303c. For example:

$$u ( t ) = {K}_{p} e ( t ) + {K}_{i} {\int }_{0}^{t} e ( τ ) d τ + {K}_{d} \frac{d}{d t} e ( t )$$

where:

K is proportional gain coefficient;

Kᵢ is integral gain coefficient;

K_{d} is derivative gain coefficient;
e(t) is error at a given time (e.g., y(t)−r(t));
t is the given time; and
τ is variable of integration representative of an initial time to the given time.

The proportional aspect 303a can generate and output a value that is proportional to the error in real time. The output of the proportional aspect can be adjusted by multiplying the error in real time by the gain coefficient Kₚ, also referred to as the proportional gain constant. The proportional aspect can be algorithmically defined by:

Pₒᵤₜ=Kₚe(t)

A relatively high proportional gain can result in a large change in u(t) for a given change in the e(t). As mentioned herein, if the proportional gain is too high, the system can become unstable. A relatively small gain can result in a small change in u(t) for a given change in e(t), and a less responsive controller. If the proportional gain is too low, the response by the controller 302 may be too small in response to disturbances. The proportional aspect 303a can be weighted to have a greater effect on u(t) than the other two aspects 303b and 303c.

The contribution from the integral term can be proportional to a magnitude of the error and/or duration of the error. The integral aspect 303b can include a summation of error over time and can provide an accumulated offset to the proportional aspect 303a. The accumulated error can be multiplied by an integral gain, such as the gain coefficient Kᵢ, and added to the output of the controller 302. The integral aspect can be algorithmically defined by:

Iₒᵤₜ=Kᵢ∫₀^{t}e(τ)dτ

The integral aspect 303b can accelerate the direction of the campaign towards r(t) and can reduce a residual steady state error that can occur with a controller with just an operating proportional aspect. A tradeoff to this acceleration can include y(t) overshooting r(t).

The derivative aspect 303c can determine a derivative of the process error in real time by determining the slope of the error over time and multiplying this rate of change by a derivative gain, such as the gain coefficient K_{d}. The derivative aspect 303c can be set at zero or weighted to have a lower effect on u(t) than the other two aspects 303a and 303b. The derivative aspect can be algorithmically defined by:

$${D}_{out} = {K}_{d} \frac{d}{d t} e ( t )$$

The derivative aspect 303c can provide a prediction on future campaign behavior and the controller 302 can use that prediction to improve settling time and stability of the campaign. In an example where the derivative aspect 303c is used, the PID controller 302 can include a low pass filter associated with the derivative aspect. The low pass filter can limit the high frequency gain and noise that obfuscate the output of the derivative aspect 303c.

Referring to FIG. 4, this figure illustrates a block diagram of an example PI controller 402 within an example feedback loop 404 within an example control system (such as the control system within campaign tuning server 116). The PI Controller 402 is an example PID controller that has switched off a derivative aspect, set the derivative aspect to zero, or completely removed the derivative aspect from the controller's circuitry. The PI controller 402 can be algorithmically defined by:

K_{P}Δ+K_{I}∫Δ(dt)

where Δ is the difference between a measured value y(t) and a set point r(t), Δ=r(t)−y(t) or a multi-dimensional function e(t) of similar nature in case of multiple goal metrics for an ad campaign.
A PI controller can be modeled using Laplace operators, such as:

$$C = \frac{G ( 1 + τ s )}{τ s} ,$$

where

G=K_{P},

G/τ=K_{I}.

Variable G can be set in the PI controller 402 to control a control tradeoff, such as overshoot versus settling time. By not including a derivative aspect, a state of a given campaign may remain steadier. Noise can destabilize a process controlled by a controller using a derivative aspect, especially when the noise is significant. In the case of a complex campaign, the noise found in analytics and data logs can be significant. Because the PI controller 402 lacks a derivative aspect, it may be less responsive to the dynamic nature of a sophisticated, ever-changing, and fast-paced online ad campaign. In such an example, the campaign may take longer to reach or at least acceptably approach r(t).

Such controllers can be especially beneficial for campaigns with a limited budget that bid for impressions and generate revenue through clicks or actions. These campaigns have margin (such as profit margin) that may depend on several campaign parameters, such as bidding policy parameters. In an example, margin and delivery can be used to determine a set point in controlling a campaign. The set point setup can include various priorities. These priorities may include ensuring that margin has a selected sign such as non-negative. They may also include winning impressions or advertiser spending as much as possible within the budget of the campaign, such as a delivery priority that is reached by a volume cap applied to the bidding process for the campaign. They may also include reaching goal margin as close as possible. A shortened tuning process and error function of the controller can be designed to maintain convergence towards such priorities while controlling some aspects of bidding policies of a campaign, such as setting a ceiling for max dynamic cost per impression (max dCPM). For example, points representing these priorities may be defined through the equilibrium surface. The values of variable r(t) may include such a surface instead of a single set point.

In some examples, margin can be defined by the difference between revenue and costs and that difference divided by revenue. In some examples of cost per click (CPC) campaigns, margin can be defined by a difference between a goal CPC and an actual CPC and that difference is divided by the goal CPC. Delivery can be defined as the advertiser spends. For example, for CPC campaigns with fixed cost per click, an advertiser may spend the number of clicks multiplied by the cost-per-click. For the sake of simplicity and illustration, a campaign operating phase described herein uses max dCPM as the controlling parameter for delivery and margin.

In an example, a goal of certain CPC and/or cost per action (CPA) scenarios is to tune bidding strategy on ad delivery so that it directs real-time margin towards a goal margin and delivery. The actual margin at a measure time can be represented by y(t) and the goal margin can be represented by r(t). An example of a goal margin may be a percentage number somewhere between 20% and 50%. In one example, the u(t) outputted by a controller (such as PID controller 302 or PI controller 402) can be or relate to dCPM. For example, the u(t) can represent a maximum dCPM. In such an example, when a bid prediction×goal max dCPM, then bidding price for an impression is set to bid max dCPM otherwise to bid prediction×goal. This bidding strategy can have a great effect on margin and delivery up until a saturation point after which increasing max dCPM stops being effective. In addition to max dCPM or any other selected variable, additional variables may add to bidding strategy. For example, two additional parameters α and β may be added, so that when α×(prediction×goal)+β≧max dCPM, then bid max dCPM; otherwise bid prediction×goal. Also, for example, in addition to max dCPM and the two additional parameters α and β, four additional parameters Y1, Y2, δ1, and δ2 may be introduced, so that when α×(prediction×goal)+β≧δ1×max dCPM, then bid Y1×max dCPM, if α×(prediction×goal)+β≧δ2×max dCPM, then bid Y2×max dCPM; otherwise bid prediction×goal. Alternatively or additionally, prediction and goal calculations can be part of a different analytic functions besides a function of a product, such as a logarithm, a square root, a ratio of polynomials, or even defined through a table of values.

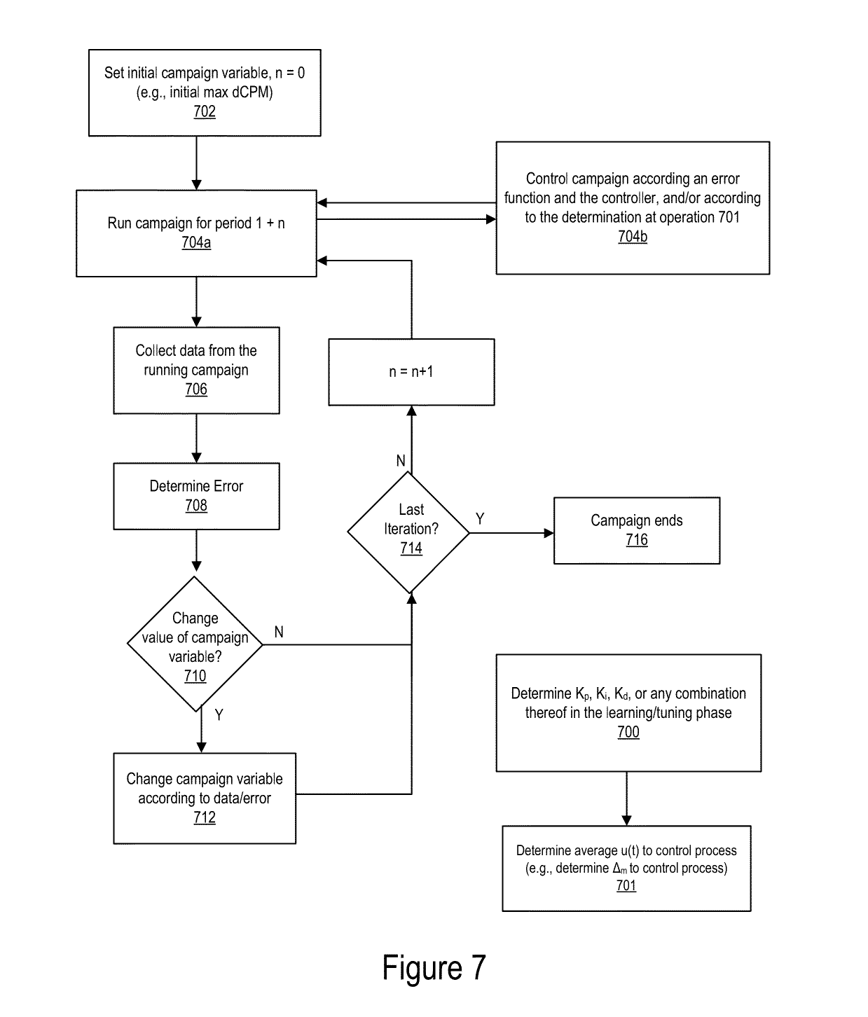

Using the example with u(t) including or related to max dCPM, an initial time period can be split into multiple time segments during a learning/tuning phase (e.g., the shorten learning phase). The multiple time segments can be equal in time span. This can significantly reducing the length of a learning/tuning phase compared to a more traditional controller tuning process. Such learning/tuning phases are used to determine possible parameters to control an operating phase, such as an operating phase in FIG. 7 including operations 702, 704a, 704b, 706, 708, 710, and 712.

In an example, a controller, such as the PID controller 302 and/or the PI controller 402, for CPC control loop scenario, can start with a “best guess” policy or a policy based on past successful models. Such a policy may include setting max dCPM to a predetermined value and then using the controller to adjust it. After simulating the control loop scenario with real ad campaign data over a shortened time period, it was found that control variables such as max dCPM can have a significant effect on margin. In such an example u(t) can include Δ_{maxdCPM(t)}, wherein:

Δ_{maxdCPM(t)}=Kₚ×Error(D(t),D_{goal},M(t),M_{goal})+Ki×∫ₛₜₐᵣₜ^{curr}Error(D(t),D_{goal},M(t),M_{goal})dt,

and wherein D_{goal} is the goal budget, D(t) is the actual budget spent in time period t, M_{goal} is the goal margin, M(t) is the actual campaign margin in time period t, Error(D(t),D_{goal}, M(t), M_{goal}) is the error function representative of whether a campaign process such as a certain bidding strategy is violating or deviating from priorities of the campaign, such as: ensuring margin is non-negative, wining impressions as much as possible within the budget (e.g., delivery goal will be reached through a volume cap applied to the bidding process), and reaching goal margin as close as possible. The error function Error(D(t), D_{goal}, M(t), M_{goal}) can be expanded for determining whether violation or unacceptable deviation from the three priorities occurs. This expansion can be given by: Error(D(t), D_{goal}, M(t), M_{goal})=F₁(M(t))+F₂(D(t), D_{goal}) F₃(M(t), M_{goal}). F1(M(t)) is a barrier function for real-time margin M(t) becoming negative. F₂(D(t),D_{goal}) is a penalty function for not satisfying the full delivery goal. F₃(M(t),M_{goal}) is a penalty function for deviating from the goal margin. This expansion can result in F₁>>F₂>>F₃, when F₁ and F₂ are positive according to a priority schema. When criteria of positive margin and full delivery are satisfied, those components contribute little to no error and tuning focuses on reaching the margin goal. In an example when F₁ and F₃ operate at or near 100%, so F₂ may also operate at or near 100%. In such an example, the three priorities may be given by:

F₁(M(t))=C₁×M(t), when M(t)<0,0, and when M(t)≧0;

F₂(D(t),D_{goal})C₂×(1−D(t)/D_{goal}), when D(t)<D_{goal},0, and when D(t)>D_{goal}; and

F₃(M(t),M_{goal})=C₃×(M(t)−M_{goal}).

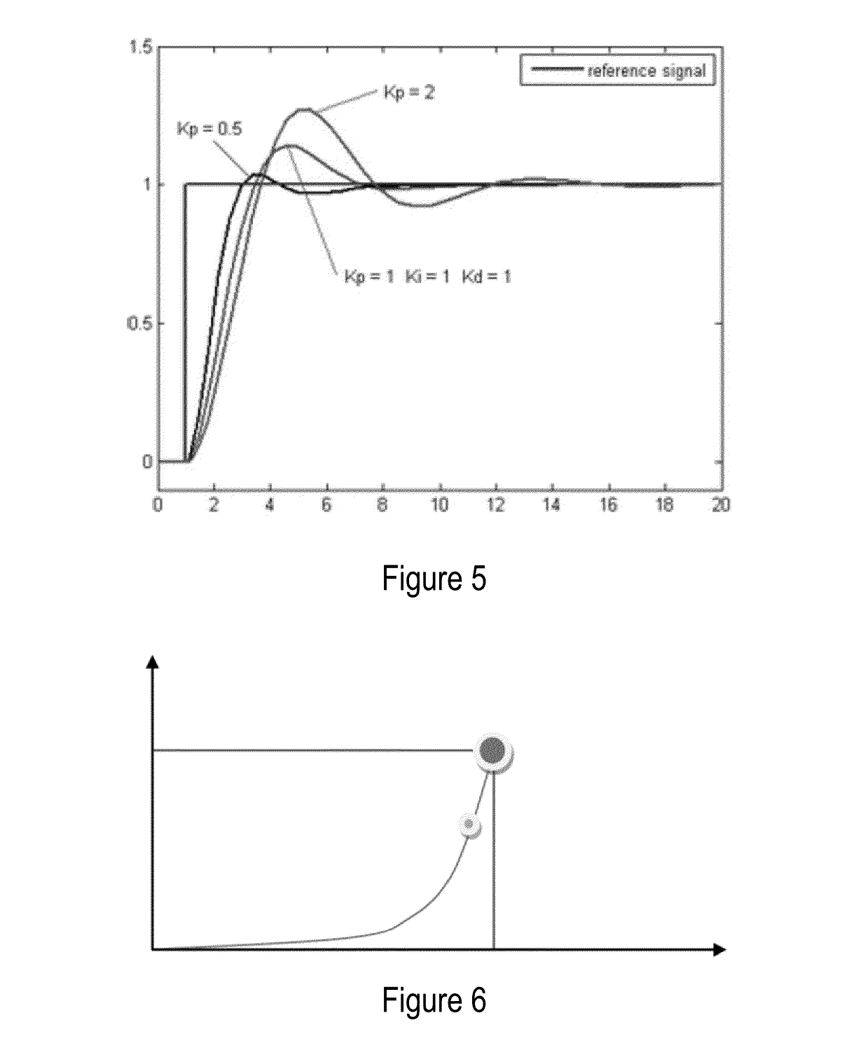

FIG. 5 illustrates a plot of y(t) versus time for three values of Kₚ. Also, plotted is a result of holding Kₚ, Kᵢ, and K_{d} constant. There are many techniques for choosing gains and then tuning them with a process control loop. One common technique includes setting Kᵢ initially to zero and starting with a relatively small Kₚ, such as 0.01, and gradually increasing Kₚ until oscillating behavior occurs. Oscillation occurring from such a technique is illustrated in FIG. 5. As depicted, as Kₚ is increased, the magnitude of the oscillation increases, the time to stability may increase. The drawback of such PID Controller tuning is its lengthy duration and the need to explore coefficient settings over a wide range of values.

In an example, coefficients can be tuned by the Ziegler-Nichols method. This method is especially useful as campaigns become more complex and noise becomes a greater factor. After obtaining an oscillating behavior while varying Kₚ with Kᵢ and K_{d} set to zero, the controller gain coefficients Kₚ, Kᵢ, and K_{d} can be set as illustrated in Table 1. In Table 1, Pᵤ represents the oscillating period and Kᵤ represents the minimal value of Kᵢ at which the controlled process starts to oscillate.

TABLE 1
Ziegler-Nichols method

| Control Type | Kₚ | Kᵢ | K_{d} |
|---|---|---|---|
| P | 0.50 Kᵤ | — | — |
| PI | 0.45 Kᵤ | 1.2 Kₚ/Pᵤ | — |
| PID | 0.60 Kᵤ | 2 Kₚ/Pᵤ | KₚPᵤ/8 |

In an example, a controller (such as the PID controller 302 or the PI controller 402) can be designed to direct a campaign towards a pre-defined arbitrary and monotonically decreasing surface from a goal point to an origin. The controller may cause the y(t) to converge to one of the points on that surface. For example, in the case of two metrics such as margin and delivery, an arbitrary monotonic line can be determined between an origin and the two goals. FIG. 6 illustrates a plot of such a line between between an origin and two goals. The curved line in FIG. 6 can represent a pre-defined arbitrary and monotonically decreasing surface from a goal point to an origin. In case of multiple campaign goal metrics, r(t) can be defined by a pre-defined arbitrary and monotonically decreasing surface in a multi-dimensional space.

To simplify, the equilibrium curve can pre-defined by a union of two segments, one having an end point in the origin and the other one having an end point in the goal point. The intersections can occur at any point within a rectangle on a plot or even at the point that corresponds to a negative margin. Such a simplified definition of the equilibrium curve can be introduced via a graphical user interface. For some values of Kₚ and Kᵢ the controlled process can oscillate or converge to a point on the curve. Selection of original values for Kₚ and Kᵢ and their tuning can factor into the oscillation and the rate of convergence. Such information can be viewed by a party of interest through a graphical user interface, such as a graphical user interface associated with any of the devices described in FIG. 1.

Without use of one of these controllers, control along with launching of an online ad campaign may be managed manually by an ad manager by adjusting parameters of the campaign, such as by adjusting targeting and pricing. A manager who operates without one of these controllers, typically may use metrics and analytics associated with the campaign. Such manual control of a campaign is usually time consuming and error prone, it can be effective only with respect to a very limited time horizon. One of the benefits of the PID Controller 302 and the PI Controller 402 is its ability to control campaign parameters over a relatively longer time horizon with relative effectiveness. These controllers can effectively run a campaign even though the controlled campaign behavior may be fluctuating for reasons unforeseeable and/or beyond a provider's control. Because of the unpredictability that may cause instability in an ad campaign when a controller is not used, a user of a controller does not need to depend on manually changing campaign parameters based on one or several of these unknown factors for the sake of ad campaign stability.

For PID controller or PI controller gain coefficient tuning, experimentation through trial and error is usually necessary. As mentioned, this experimentation can often take a significant amount of time. Besides the techniques already described herein, a combined automatic and manual approach may be effective as well.

A combined approach can use both a manual and an automated approach for different types of controller, such as a PID controller or PI controller. This approach can include a shortened learning/tuning phase to gain a workable level of confidence in the controller. The purpose of the shortened period is to determine gains of the controller, such as gain coefficients Kₚ, Kᵢ, and K_{d} for a PID controller or Kₚ and Kᵢ for a PI controller. Also, this shorten period may be sufficient to verify the functional design of an error function associated with the controller and an average u(t).

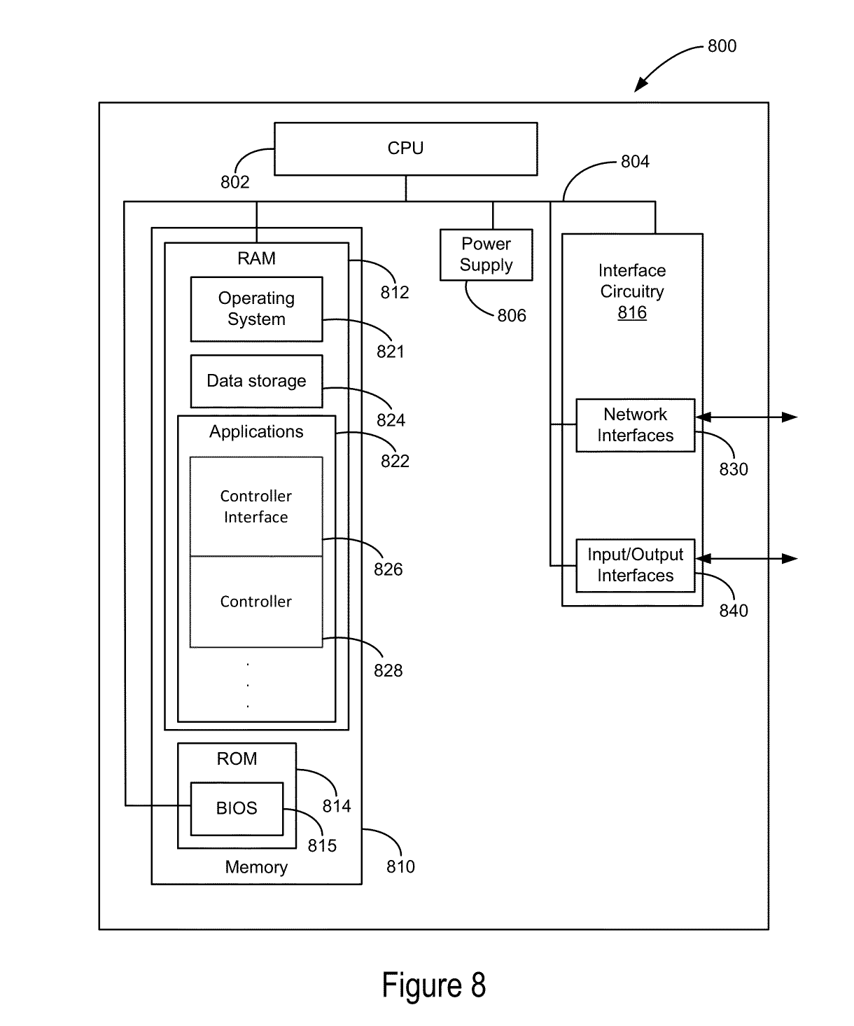

FIG. 7 illustrates example operations performed by a system, such as the information system illustrated in FIG. 1, which can provide online ad campaign control using a controller, such as a PID controller, PI controller, or a P controller. The operations can begin with an aspect of the system (such as controller interface 826 illustrated in FIG. 8) setting an initial value of a selected variable of an online ad campaign, at 702. In an example, the selected variable can include a parameter of an ad campaign bidding policy (such as max dCPM or CPC goal). The aspect of the system can communicate with, run, and/or initiate the campaign, at 704a. The aspect can also collect campaign data or facilitate collection of campaign data by another aspect of the system (such as circuitry of the analytics server 118), at 706. The aspect can also calculate error and accumulated error, at 708. While the campaign is running at 704a, a controller, such as a P controller, a PI controller (e.g., PI controller 402), or a PID controller (e.g., PID controller 302), can control a process of the campaign according to an error function, at 704b. Additionally or alternatively, the controller, can control the process according to an averaged u(t), at 704b. Additionally or alternatively, the running of the campaign and the control of it may be simulated at 704a and 704b. Based on the collected campaign data (such as margin, delivery, and error data), the aspect can determine whether to change the value of the selected variable of the campaign at 710. If it is determined to change the value of the selected variable, the aspect of the system can determine a degree to change the value of the variable and in which direction to change the value (such as in a positive or a negative direction), at 712. The operating phase, which can include operations 702, 704a, 704b, 706, 708, 710, and 712, can reoccur in time periods for a predetermined number of iterations. At 714, the aspect can determine whether the aspect is interfacing a final iteration of the operating phase. If it is determined that it is not the final iteration, then the aspect iterates the process to the next period and performs the running and/or the initiation of the campaign at 704a and other operations of the operating phase. After the final iteration (such as due to running out of funds or a length of time given for the campaign), the campaign ends at 716.

Prior to the operating phase, in a learning/tuning phase of the controller, for example, at 700, the aspect can determine gain coefficients Kₚ, Kᵢ, K_{d}, or any combination thereof for the controller. In an example, once the gain coefficient(s) are determined, such coefficients may be used with the controller to drive the operating phase. In an example, the aspect can remove outliers (such as noise induced outliers) and calculate Kₚ as an average (such as a mean) of the set {Δ₂/E₁, Δ₃/E₂, . . . , Δₙ/Eₙ₋₁}, where Δⱼ is deviation of the y(t) from the set point r(t) after time period j, and where Eⱼ is the value of error function e(t) after time period j. In such an example, the aspect can calculate K′ₚ as half of Kₚ. Also, in such an example, the aspect can remove outliers and calculate Kᵢ as an average (such as a mean) of the set {(Δ₂−K′ₚ×E₁)/ErrAcc₁, (Δ₃−K′ₚ×E₂)/ErrAcc₂, . . . , (Δₙ−K′ₚ×Eₙ₋₁)/ErrAccₙ₋₁}, wherein ErrAccⱼ is the value of the summation of error values after time period j. At 701, the aspect can also determine an average u(t) in the learning/tuning phase of the controller (e.g., determine Δₘ=K′ₚ×Eₘ₋₁+Kᵢ×ErrAccₘ₋₁, where Δₘ is equivalent to the mean deviation of the y(t) from the set point r(t)), and switch the controller to output the average u(t) to control the process of the campaign (such as at 704b).

In an example, the initial value of the selected variable is an initial value for max dCPM price. In such an example, optimization to max dCPM price over time (such as prices P₁, P₂, . . . , Pₙ illustrated in Table 2) may coincide with a direction defined by a sign of the error function. An initial max dCPM price P₁ and a determination to adjust it is based on campaign metrics (such as based on values of key metrics for margin, Mᵢ, and delivery, Dᵢ, illustrated in Table 2). The design of the error function should be such that the adjustment determination maintains the desired sign of the error function. For example, a decision maker, such as an ad manager, may prefer to move max dCPM in a direction in synch with the sign of the error function. A conflict between the desired impact of changing a campaign parameter and the sign of the error function may suggest that the error function design should be adjusted.

An operating phase may include a first period and an amount of the change to max dCPM in the first period may be a simple approximation, such as a best guess or by the binary search rule. Such a guess in the change to max dCPM during the first period may not exceed 50% up or down. The first period may be divided into further periods and these periods, such as a second period and a third period, may include a series of diminishing changes to the max dCPM parameter that may be based on extrapolation or manual changes that do not accumulate to an amount of change to the max dCPM exceeding 50%. In other words, the guessed change should not exceed 50% of a given max dCPM and/or should be a part of a series of diminishing changes to max dCPM. Within an example operating phase, such as in a second period after a first period and in follow-up time periods, the change may be a guess, but when based on a linear and/or higher-degree approximations it can derive more precise estimates of max dCPM changes.

Table 2 illustrates a table data structure that can store information associated with periods of an operating phase, such as an operating phase just after or combined with a shortened learning/tuning phase. The first column labeled “Step” indicates five time periods of such an operating phase. The second column labeled “Max dCPM” indicates the max dCPM price per period indicated in the first column. The third column labeled “Δ” indicates Δ_{maxdCPM(t)} and constitutes the calculated output value u(t). In other words, the third column indicates a difference between a measurable variable outputted by the campaign and the set point. The fourth column labeled “Margin” indicates the margin metric values per period indicated in the first column. The fifth column labeled “Delivery” indicates the delivery metric values per period indicated in the first column. Metric values can comprise a vector reading of the metrics y(t). The sixth column labeled “Error” indicates the error function value e(t) per period indicated in the first column and represents deviations between the y(t) and r(t). The seventh column labeled “Acc Error” indicates a summation of previous error values through the corresponding period in the first column.

TABLE 2

| Step | Max dCPM | Δ | Margin | Delivery | Error | Acc Error |
|---|---|---|---|---|---|---|
| 1 | P₁ | 0 | M₁ | D₁ | E₁ | E₁ |
| 2 | P₂ | Δ₂ | M₂ | D₂ | E₂ | ErrAcc₂ |
| 3 | P₃ | Δ₃ | M₃ | D₃ | E₃ | ErrAcc₃ |
| 4 | P₄ | Δ₄ | M₄ | D₄ | E₄ | ErrAcc₄ |
| 5 | P₅ | Δ₅ | M₅ | D₅ | E₅ | ErrAcc₅ |

Subsequent to generating a data structure such the table illustrated in Table 2, the system can estimate Kₚ according to the data stored in the data structure. Such an estimated Kₚ may have a scale that directs a respective controller to exhibit behavior sufficiently similar to a controller that has been through a full learning/tuning phase. In an example, Kₚ can be determined by calculating an average, such as a mean, of ratios of a Δ from a time period just prior to a given time period and error from the given time period (e.g., Kₚ=Σᵢ(Δᵢ/Eᵢ₋₁)/(n−1)≈Average of Δ₂/E₁, Δ₃/E₂, Δₙ/Eₙ₋₁). In determining the value of Kₚ, the system may use those ratios that are sufficiently close to the goals in order to tune the P-component of the PI controller more accurately. In this sense, an example first period may be a shortened learning/tuning phase.

Upon calculating a gain coefficient Kₚ that linearly directs the process towards campaign goals, the system can determine Kᵢ. In an example, a shortened learning/tuning phase can be divided between the proportional and integral aspect. In such an example, K′ₚ=Kₚ/2 and Kᵢ=Σᵢ[(Δᵢ−K′ₚ×Eᵢ₋₁)/(ErrAccᵢ₋₁)]/(n−1)≈Average of (Δ₂−K′ₚ×E₁)/(ErrAcc₁), (Δ₃−K′ₚ×E₂)/(ErrAcc₂), . . . (Δₙ−K′ₚ×Eₙ₋₁)/(ErrAccₙ₋₁). In an example, the goal of the shortened learning/tuning phase is to ensure the error function provides sufficient guidance in that the direction of max dCPM changes coincides with the sign of the error function, verify that the error function scale is in synch with the desired changes of max dCPM, that the estimated values of Kₚ and Kᵢ direct the controller sufficiently similar to a control tuned by a full manual converging process, or any combination thereof.

FIG. 8 is block diagram of example electronic device, such as a server, that can implement aspects of and related to an example control system, such as a control system of the campaign tuning server 116. The control system can include controller interface circuitry and controller circuitry (such as controller interface 826 and controller 828). The controller 828 can include a proportional aspect, an integral aspect, a derivative aspect, or any combination thereof (such as the PI controller 402 of FIG. 4 or a PID controller 302 of FIG. 3).

The electronic device 800 can include a CPU 802, memory 810, a power supply 806, and input/output components, such as network interfaces 830 and input/output interfaces 840, and a communication bus 804 that connects the aforementioned elements of the electronic device. The network interfaces 830 can include a receiver and a transmitter (or a transceiver), and an antenna for wireless communications. The network interfaces 830 can also include at least part of the interface circuitry 816. The CPU 802 can be any type of data processing device, such as a central processing unit (CPU). Also, for example, the CPU 802 can be central processing logic.

The memory 810, which can include random access memory (RAM) 812 or read-only memory (ROM) 814, can be enabled by memory devices. The RAM 812 can store data and instructions defining an operating system 821, data storage 824, and applications 822, such as applications implemented through hardware including the controller interface 826 and the controller 828. The applications 822 may include hardware (such as circuitry and/or microprocessors), firmware, software, or any combination thereof. The ROM 814 can include basic input/output system (BIOS) 815 of the electronic device 800. The memory 810 may include a non-transitory medium executable by the CPU.

The power supply 806 contains power components, and facilitates supply and management of power to the electronic device 800. The input/output components can include at least part of the interface circuitry 816 for facilitating communication between any components of the electronic device 800, components of external devices (such as components of other devices of the information system 100), and end users. For example, such components can include a network card that is an integration of a receiver, a transmitter, and I/O interfaces, such as input/output interfaces 840. The I/O components, such as I/O interfaces 840, can include user interfaces such as monitors, keyboards, touchscreens, microphones, and speakers. Further, some of the I/O components, such as I/O interfaces 840, and the bus 804 can facilitate communication between components of the electronic device 800, and can ease processing performed by the CPU 802.

The electronic device 800 can send and receive signals, such as via a wired or wireless network, or may be capable of processing or storing signals, such as in memory as physical memory states, and may, therefore, operate as a server. The device 800 can include a single server, dedicated rack-mounted servers, desktop computers, laptop computers, set top boxes, integrated devices combining various features, such as two or more features of the foregoing devices, or the like.

1. A system stored in a storage device executable by a processor, comprising:
controller interface circuitry configured to:
receive a measured process variable of an online ad campaign, a respective goal variable, and a proportional gain coefficient; and
determine an error variable according to the measured process variable and the goal variable; and
controller circuitry configured to:
receive the error variable; and
calculating pricing of the online ad campaign according to the error variable, wherein the calculating includes:
a determination of a controlled input variable according to the error variable and the proportional gain coefficient; and
a communication of the controlled input variable to adjust the pricing of the online ad campaign.

2. The system of claim 1, wherein error variable is an error function and a difference between the measured process variable and the goal variable.

3. The system of claim 1, wherein the controller circuitry includes a proportional aspect and the proportional aspect is configured to determine the controlled input variable according to the error variable and the proportional gain coefficient.

4. The system of claim 1, wherein the pricing is associated with dynamic cost per impression.

5. The system of claim 1, wherein the online ad campaign delivers advertising via multiple online advertising channels.

6. The system of claim 1, wherein tuning of the controller circuitry is periodic instead of continuous and each period of the tuning includes extrapolation.

7. The system of claim 6, wherein the extrapolation diminishes with each subsequent period of the tuning.

8. The system of claim 1, wherein the proportional gain coefficient at an initial period of tuning the controller circuitry includes an approximated value instead of zero.

9. The system of claim 8, wherein an ad campaign variable is configured to maintain a selected sign of the controlled input variable instead of converge to a set point.

10. The system of claim 9, wherein the error campaign variable is further configured to converge to an equilibrium surface instead of the set point.

11. The system of claim 1, wherein the campaign variable is configured to converge to an equilibrium surface instead of a set point.

12. The system of claim 1, wherein the campaign variable is configured to maintain a selected sign instead of converging to a set point.

13. A method, comprising:
setting a set point for controlling pricing of an online ad campaign, by controller interface circuitry;
setting a plurality of goal points of an equilibrium surface for controlling the pricing of the online ad campaign, by the controller interface circuitry;
directing, by controller circuitry communicatively coupled to the controller interface circuitry, a parameter of the online ad campaign towards the set point; and
where the direction of the parameter towards the set point results in the online ad campaign being marginally stable or unstable, redirecting the parameter towards the equilibrium surface.

14. The method of claim 13, further comprising: tuning, by the controller interface circuitry, the controller circuitry according to the equilibrium surface.

15. The method of claim 14, further comprising: determining, by the controller interface circuitry, a proportional gain coefficient of proportional circuitry of the controller circuitry according to the tuning.

16. The method of claim 15, further comprising: directing, by the controller circuitry, the parameter of the online ad campaign towards the set point, the equilibrium surface, or both, according to at least the proportional gain coefficient.

17. The method of claim 13, wherein the plurality of goal points includes a goal point to ensure that margin has a selected sign.

18. The method of claim 13, wherein the plurality of goal points includes a goal point to ensure that the online ad campaign is winning impressions as much as possible within a budget of the online ad campaign.

19. The method of claim 13, wherein the plurality of goal points includes a goal point to ensure that the online ad campaign is reaching goal margin as close as possible.

20. A method, comprising:
setting a set point for controlling pricing of an online ad campaign, by controller interface circuitry;
directing, by controller circuitry, a parameter of the online ad campaign towards the set point;
tuning, by the controller interface circuitry, the controller circuitry according to a learning/tuning phase;
determining, by the controller interface circuitry, a proportional gain coefficient of proportional circuitry of the controller circuitry and an integral gain coefficient of integral circuitry of the controller circuitry, according to the tuning; and
directing, by the controller circuitry, the parameter of the online ad campaign towards the set point according to at least the proportional gain coefficient and the integral gain coefficient.
